(19) United States
(12) Patent Application Publication
(10) Pub. No.: US 2006/0195681 A1
(43) Pub. Date: Aug. 31, 2006

(54) Test program instruction generation

(75) Inventors: Simon John Craske, Cambridge (GB); Eric Jason Furbish, Mougins (FR); Jonathan William Brawn, Austin, TX (US)

Correspondence Address: NIXON & VANDERHYE, PC, 901 NORTH GLEBE ROAD, 11TH FLOOR, ARLINGTON, VA, 22203, US

(73) Assignee: ARM LIMITED, Cambridge (GB)

(21) Appl. No.: 11/354,239

(22) Filed: Feb. 15, 2006

Related U.S. Application Data
(63) Continuation-in-part of application No. 11/004,571, filed on Dec. 6, 2004.

(51) Int. Cl. G06F 15/00

(52) U.S. Cl. 712/224

(57) ABSTRACT

An architectural definition of an instruction set is parsed to identify distinct program instructions therein. These distinct program instructions are associated with operand defining data specifying the variables they require. A complete set of such distinct program instructions and their associated operand defining data is generated for the instruction set architecture and used to automatically generate instruction-generating code in respect of each of those distinct program instructions. The instruction-generating code can include an instruction constructor, an instruction mutator and an instruction encoder. The instruction-generating code which is automatically produced may be used by genetic algorithm techniques to develop test programs exploring a wide range of functional state of a data processing system under test. The architectural definition can also be parsed to identify a set of architectural state which may be reached excluding unreachable architectural points and unpredictable architectural points.

### BACKGROUND OF THE INVENTION

1. Field of the Invention

This invention relates to the field of data processing systems. More particularly, this invention relates to techniques of automatically generating test program instructions for testing a data processing system.

2. Background of the Invention

As data processing systems increase in complexity, there is an increasing need for rapid and thorough testing of such data processing systems. One known technique is to execute test programs upon such data processing systems to check that the results produced match those expected. A difference between the expected and the actual results indicates a design or manufacturing defect. In order to thoroughly test data processing systems with their high levels of complexity it is important to try to place the data processing system into as broad a range of functional states as possible in order to more reliably identify problems which may occur only in a small number of functional states of the system. In order to generate the large test programs required to comprehensively test data processing systems, it has been proposed to write computer programs that will generate test programs. However, the computer programs for generating test programs are in themselves large and complex and represent a considerable investment in time, effort and skill.

### SUMMARY OF THE INVENTION

Viewed from one aspect the present invention provides a method for automatically generating a set of co-operative testing mechanisms for testing a data processing apparatus from an architectural definition of at least one instruction set of said data processing apparatus, said method comprising:
(i) parsing said architectural definition to identify features of the data processing apparatus to create said set of co-operative testing mechanisms;
(ii) generating from at least some of said features of said data processing apparatus a simulation tool operable to simulate the behaviour of said data processing apparatus;
(iii) generating from at least some of said features of said data processing data providing characteristics of said at least one instruction set for supply to a test generation tool.

The present technique serves to enable the automatic generation of test programs. At the base of the system is an architectural definition of the data processing apparatus under test. This architectural definition can be parsed rigorously and comprehensively to extract features of the data processing apparatus under test. These features can be used to form a simulation tool and characteristics of an instruction set for use in test generation. The comprehensive and rigorous nature of the manner in which the common architectural data is formed serves to generate a collection of testing mechanisms of consistent and reliable quality.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 schematically illustrates the formation of co-operative testing mechanisms;

FIG. 2 schematically represents a hierarchical definition of the instruction set architectures of a data processing apparatus;

FIG. 3 schematically illustrates a distinct program instruction with its associated operand defining data;

FIG. 4 schematically illustrates the formation of instruction-generating code from data defining of a distinct instruction and its associated operand defining data;

FIG. 5 schematically illustrates the use of instruction-generating code combined with test program templates and test program instruction weighting data;

FIG. 6 is a flow diagram illustrating the parsing of an architectural definition to extract features for generating a simulator tool and for supply to a test generating tool;

FIG. 7 is a flow diagram illustrating the formation of instruction-generating code form an architectural definition of a data processing apparatus;

FIG. 8 is a flow diagram schematically illustrating the generation of data defining a set of functional states which may be adopted by a data processing apparatus;

FIG. 9 is a flow diagram illustrating generation of a simulation tool;

FIG. 10 is a flow diagram illustrating forming data for use by a test generating tool; and

FIG. 11 schematically illustrates a general purpose computer of the type which may be used to implement the above techniques;

### DESCRIPTION OF THE PREFERRED EMBODIMENTS

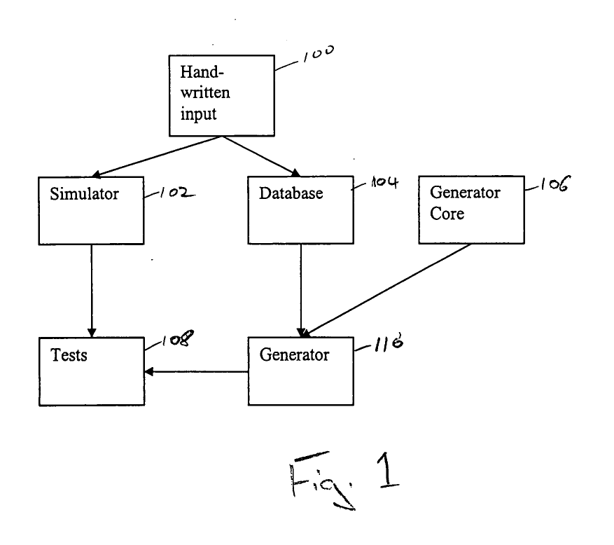

FIG. 1 schematically illustrates an arrangement by which a single hand-written hierarchical definition 100 is used to generate both a simulation tool 102 and a database 104 of instruction characteristics. The database 104 together with a generator core 106 can then be used to generate a test program generator 110 which will in turn generate test programs to explore and test the range of architectural state provided by the system defined in the architectural definition 100. The test programs generated by the test program generator 110 together with the simulation tool 102 serve together to provide tests 108 used to ensure correct/desired operation of the data processing system which is being modelled. It will be seen from FIG. 1 that a single hand-written hierarchical architectural definition 100 is used as a source to generate co-operative testing mechanisms 102, 104, 110, 108 which can be used to test the design in question. The term testing mechanism will be understood by those in this technical field to typically represent software and associated data used to model the behaviour of a device rather than the provision of a physical device itself.

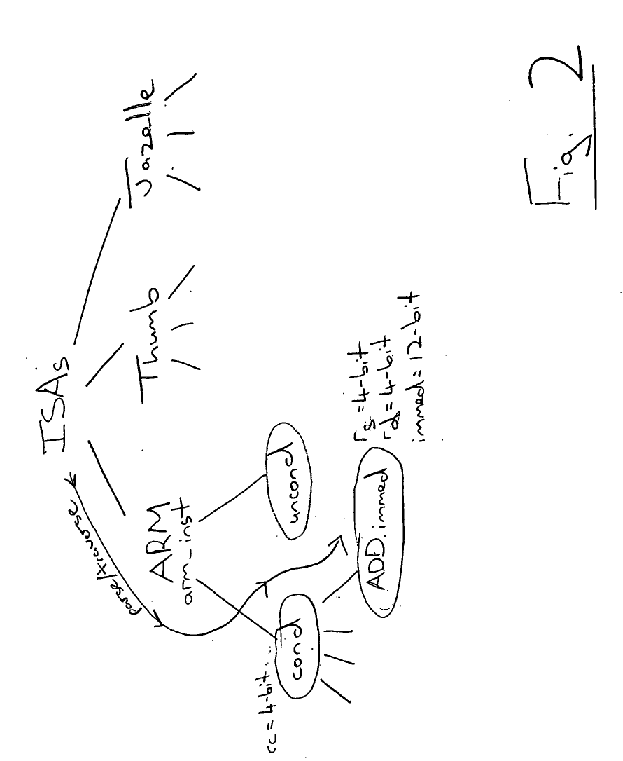

FIG. 2 schematically illustrates a hierarchical architectural definition of the instruction set architectures of a data processing apparatus. In this example, the data processing apparatus is an ARM processor of the type which supports the ARM, Thumb and Jazelle instruction sets. As is illustrated, the ARM instruction set may be broken down in layers within a tree-like structure. The first division is represented as being between conditional and unconditional instructions. Below the conditional instructions the ADD immediate instruction is one distinct type of program instruction. The distinct ADD immediate instruction has its own static opcode and various operand defining fields. In this illustrated example, the distinct program instruction is an ADD immediate instruction and accordingly the operand fields include a source register specifier, a destination register specifier and an immediate value specifier.

Whilst it will be appreciated that effort is required from skilled engineers to form the architectural definition, this architectural definition is capable of considerable re-use as it will likely be un-altered, or only slightly altered, in different implementation and evolve gradually with time. It is common for many specific implementations of data processing apparatus which will require separately testing and have differing micro-architectures targeted at different applications to nevertheless share a common instruction set of architectural definition at the level illustrated in FIG. 2. Thus, the effort in producing an architectural definition is amortised as it is reused many times for testing many different processor implementations.

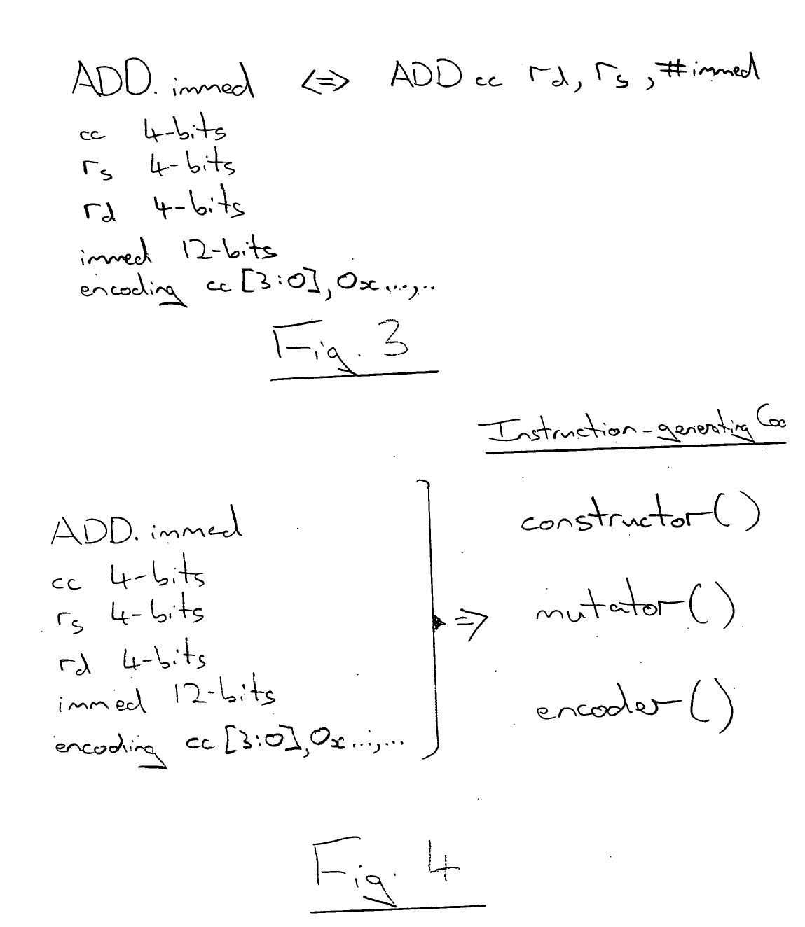

FIG. 3 schematically illustrates the distinct program instruction shown in FIG. 1 in more detail. In this example the distinct program instruction type identified is an ADD immediate instruction. The associated operand defining data includes a 4-bit field defining the condition codes associated with this ARM instruction, a 4-bit field defining the source register, a 4-bit field defining the destination register and a 12-bit field defining the immediate value which is to be added to the value stored in the source register with the result being stored in the destination register. Also associated with the ADD immediate instruction is data defining its encoding. As illustrated the condition codes are at one end of the instruction coding followed by a static opcode field followed by various other fields, including the above variable specifying fields as well as potentially other static opcode fields.

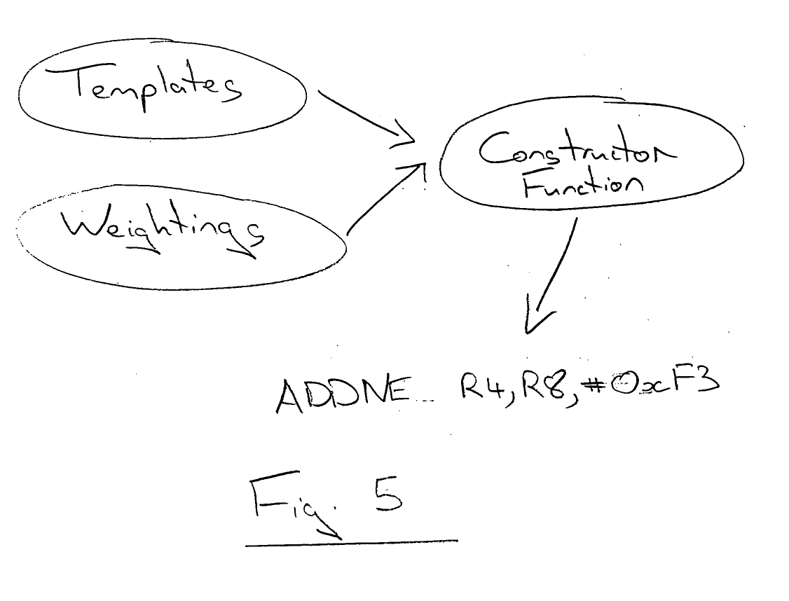

FIG. 4 illustrates how the data of FIG. 3 relating to a distinct program instruction and its operand defining data is used to form different types of instruction-generating code. The data for the distinct program instruction is read and used to form functions which concatenate the elements of the instruction in accordance with various settings (e.g. weighting data, template data, etc as will be discussed later). The parsing of the architectural definition in FIG. 1 is conducted automatically so as to methodically extract all different distinct program instructions and then associate their operand defining data therewith. Thus, a comprehensive list of distinct program instructions, FIG. 2 illustrating one member of this list, is formed and provides an input to the program code which then goes on to form instruction-generating code for each of those distinct program instructions.

The instruction-generating code produced may implement an instruction constructor function, an instruction mutator function or an instruction encoder function. The instruction constructor forms a new specific instance of a test program instruction using at least partially specified operand variables and/or random operand variables in accordance with settings applied to that constructor, such as via a weighting or template file, which has been user defined. A mutator function is also formed as one of the types of instruction generating code and serves to take as an input an already existing test instruction and mutates/alters this in accordance with predetermined (e.g. user specified) rules and degrees of freedom to form a mutated test instruction. This mutation mechanism is useful when the test program instructions are being processed by genetic algorithms seeking to form sequences of test program instructions which exercise the target data processing apparatus under test to adopt a wide range of functional states. The encoder function serves to form a binary executable form of a test program instruction, such as a 32-bit instruction word in the case of an ARM instruction.

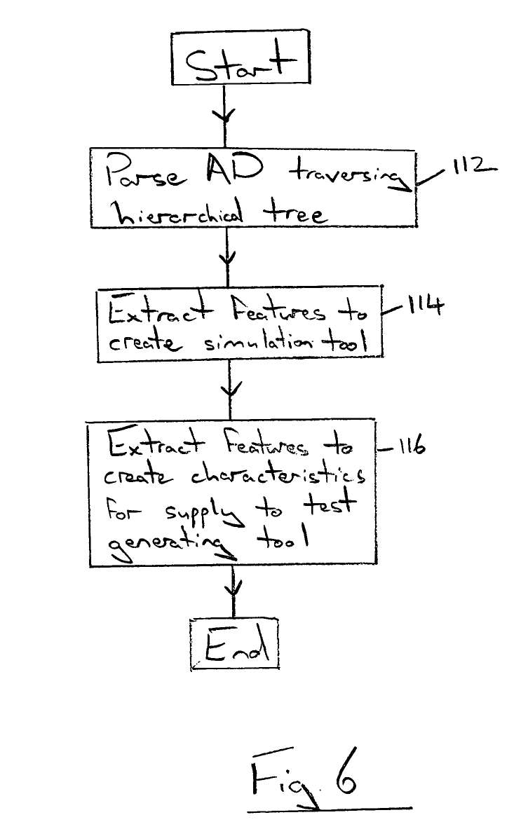

FIG. 5 schematically illustrates the use of the construction function to generate a test program instruction. The example used is again an ADD immediate instruction. The construction function takes as its settings inputs data from a weightings file and a templates file. The weightings file can specify data to influence the type of operand variables employed to complete the operand fields within the test program instruction generator. As an example, the 4-bit register fields may be specified as being randomly selected. Alternatively, specific register numbers may be given a different weighting to either favour or disfavour their adoption. Certain registers serve specific functions, such as the PC, the stack pointer, etc and thus may desirably be subject to greater or less selection. The condition code field may again be weighted so as, for example, to exclude condition codes of no interest, e.g. the condition code representing never executed is of limited interest and so should be disfavoured in selection within the test program instructions. The particular example illustrated forms the ADD immediate instruction to have a condition code indicating its execution when the non zero flag is set, the destination register is set as 4, the source register is set as 8 and the immediate value is set as the hexadecimal value F3.

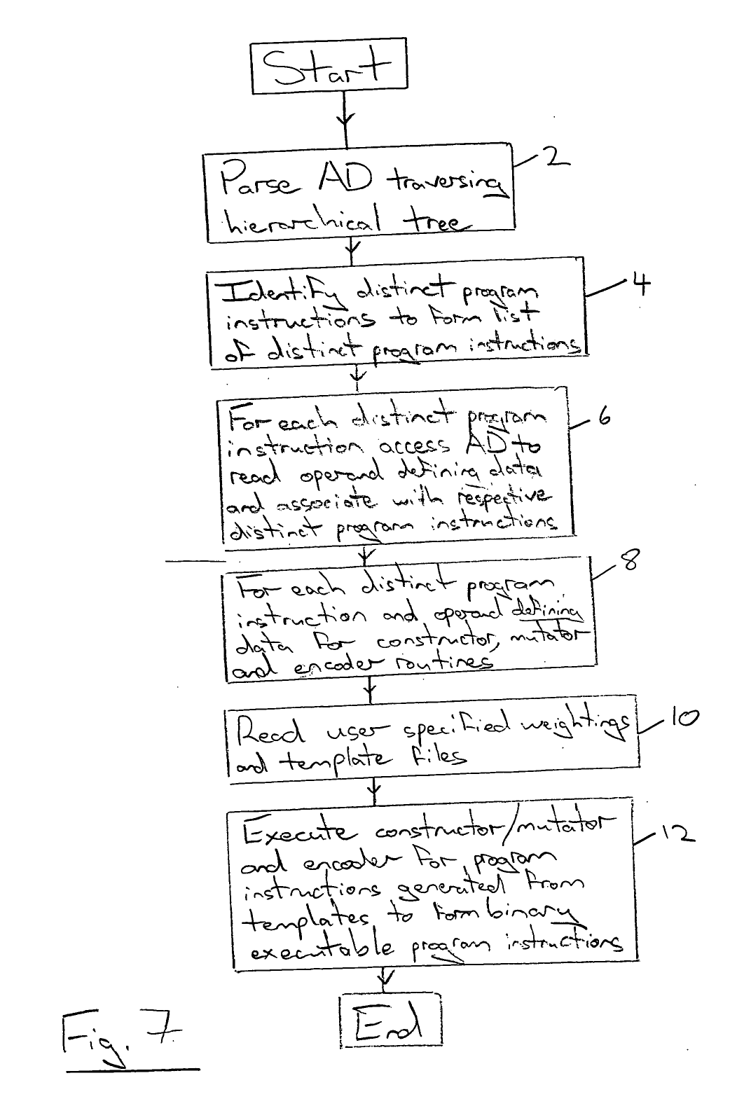

FIG. 6 is a flow diagram illustrating the parsing of an architectural definition in the form of a hierarchical tree at step 112, This hierarchical tree may be rigorously traversed automatically to visit all points and all combinations. Step 114 extracts features from the parsed architectural definition and uses these to create a simulation tool. The simulation tool will typically take the form of an instruction set simulator as will be known to those in this technical field. At step 116 features extracted from the parsing of the architectural definition are used to create characteristics for supply to a test generating tool defining characteristics of instructions associated with the architectural definition which can be executed (at least in simulation) by the simulation tool already created. These characteristics typically define operand ranges, types, biasing and the like.

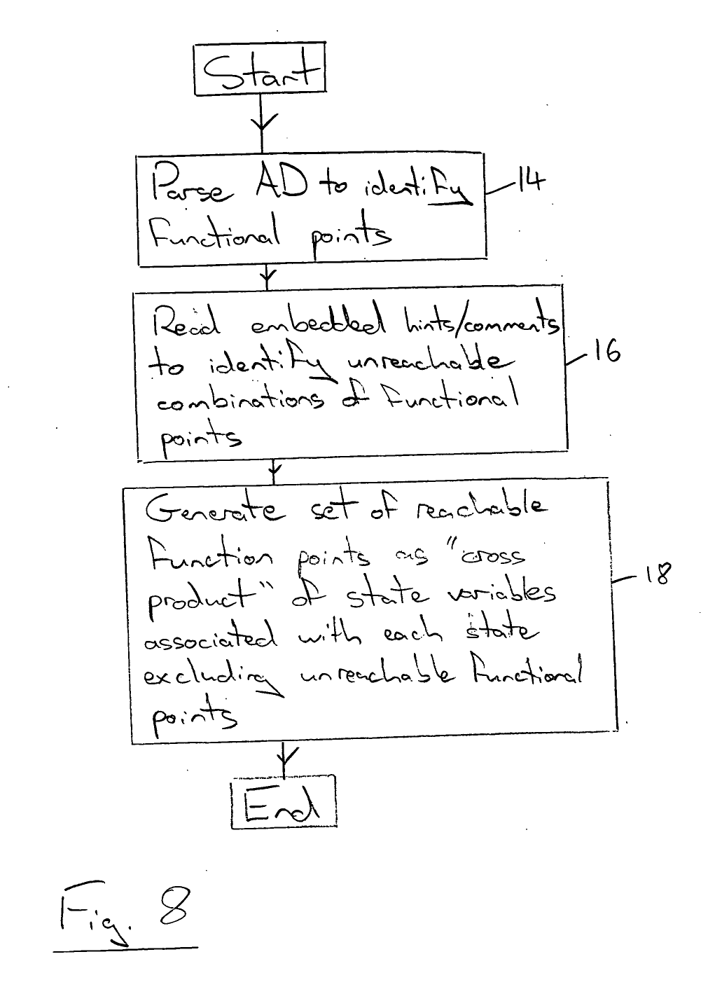

FIG. 7 is a flow diagram schematically illustrating the formation of instruction-generating code from an architectural definition and the use of that instruction-generating code. At step 2 an architectural definition of a data processing apparatus, or at least the instruction set architecture thereof, is parsed/traversed as illustrated in FIG. 2. Step 4 identifies the distinct program instructions forming the “leaves” in the hierarchical definition tree and forms these into a list of distinct program instructions. Step 6 then processes this list of distinct program instructions and revisits the architectural definition for each distinct program instruction to identify the operand defining data to be associated with that distinct program instruction. This then forms for each distinct program instruction data including the information illustrated in FIG. 3.

Step 8 executes a program which reads the data defining each distinct program instruction and its associated operand defining data in turn and for each of those elements automatically generates code to serve as a constructor, mutator and encoder for that element. As an example, in the case of the ARM instruction set there may be in the order of one thousand possible distinct program instructions identified by the parsing of the architectural definition of the ARM instruction set and constructor, mutator and encoder functions are automatically generated for each of those distinct program instruction types. The Thumb instruction set would typically have many fewer distinct program instruction types since it is a shorter 16-bit instruction set. The Jazelle instruction set is shorter still since it is primarily populated with the relatively few Java opcode types.

Step 10 serves to read user specified weighting and template files in respect of the generation of test program instructions required by a particular user. Step 12 then executes the appropriate constructor/mutator functions followed by the encoder functions to form specific test program instructions, such as illustrated in FIG. 4, and then the encoder function transforms these into 32-bit executable form in the case of ARM instructions.

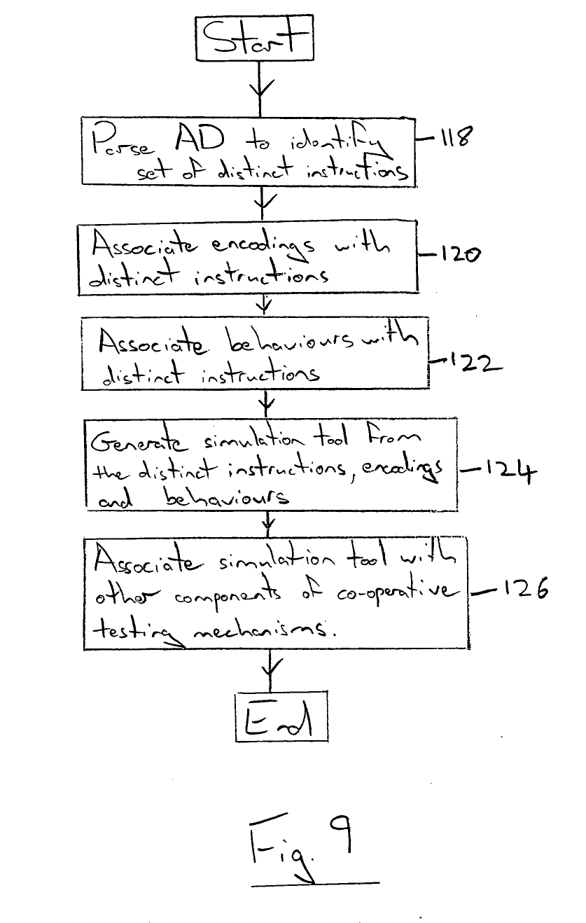

FIG. 8 illustrates a further use of the architectural definition of FIG. 2. At step 14 the architectural definition is parsed to identify different functional points therein. These functional points may be inherent, such as a point identifying a distinct program instruction type. In addition to such inherent functional points, user specified annotations may define functional points of particular architectural interest. These user defined functional points may then be targeted by the test program generation mechanisms such that they are thoroughly explored. As an example, a write to the PC register can be flagged as a functional point of interest within the class of writes to registers in general. A write to the PC register results in a program branch, which is a type of processor operation that should be thoroughly tested.

Step 16 illustrates the reading of embedded hints/comments within the architectural definition of FIG. 1 to identify unreachable combinations of functional points. It will be appreciated that certain combinations of functional state may in practice be unreachable. Alternatively, some combinations of functional states may be known to produce unpredictable results and this unpredictability forms part of the architectural definition with the users knowing to avoid such combinations of states. These unreachable and unpredictable states may accordingly be identified rigorously and methodically by the parsing of the architectural definition and excluded from a set of reachable functional points formed at step 18 which it is desired to broadly explore during test program execution. The functional points to be explored can be considered to be the cross product of the various state variables associated with the data processing apparatus excluding those combinations which have been identified as unreachable or unpredictable.

The above described techniques for constructing, mutating and encoding test program instructions can be employed by genetic algorithms to form candidate test programs for evaluation. These candidate test programs may be subject to instruction set simulator execution to determine the functional points reached by such execution. The set of functional points so reached may be compared with the set of functional points identified in step 18 of FIG. 6 to determine the breadth of coverage of the candidate test program under investigation. That candidate test program may then be subject to automated mutation by a genetic algorithm to vary its form and re-tested for its breadth of coverage. In this way, a test program can be automatically generated giving a broad range of functional point coverage. In the context of such genetic algorithm approaches to test program generation the comprehensive and thorough provision of instruction-generating code for all distinct program instructions is important since the genetic algorithms need access to mechanisms for automatically generating test program instructions of whatever type their feedback mechanisms indicate are desirable.

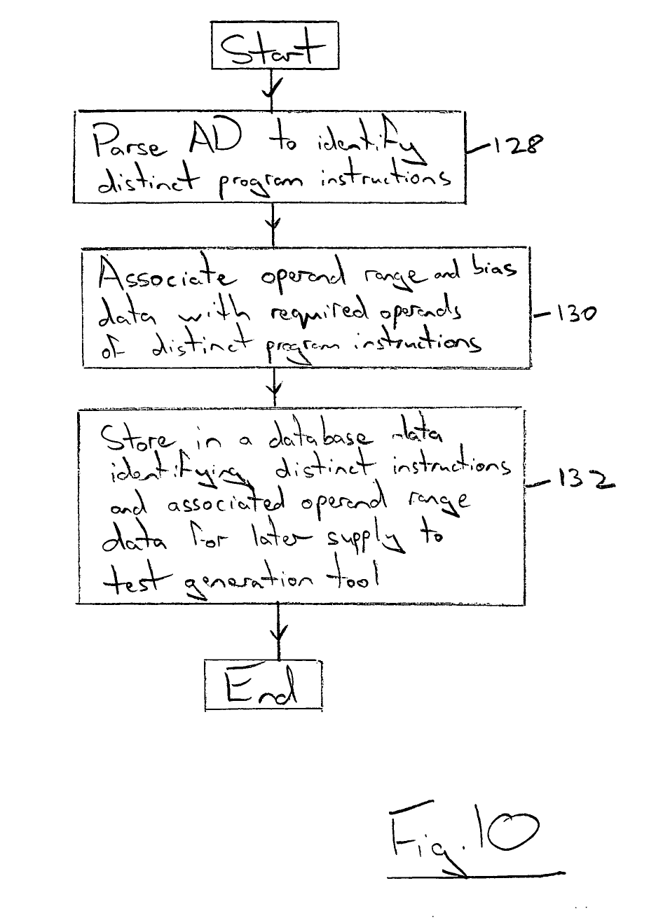

FIG. 9 is a flow diagram illustrating the generation of a simulation tool. At step 118 the architectural definition is parsed to identify a set of distinct instructions. At step 120 encodings for the identified distinct instructions are associated therewith. At step 122 the behaviours for the distinct instructions are also associated with those instructions. At step 124 the distinct instructions identified at step 118, the encodings associated at step 120, and the behaviours associated at step 122, are used to generate a simulation tool, such as an instruction set simulator, for use as one of a co-operative set of testing mechanisms. Step 126 associates the generated simulation tool with the co-operative testing mechanisms.

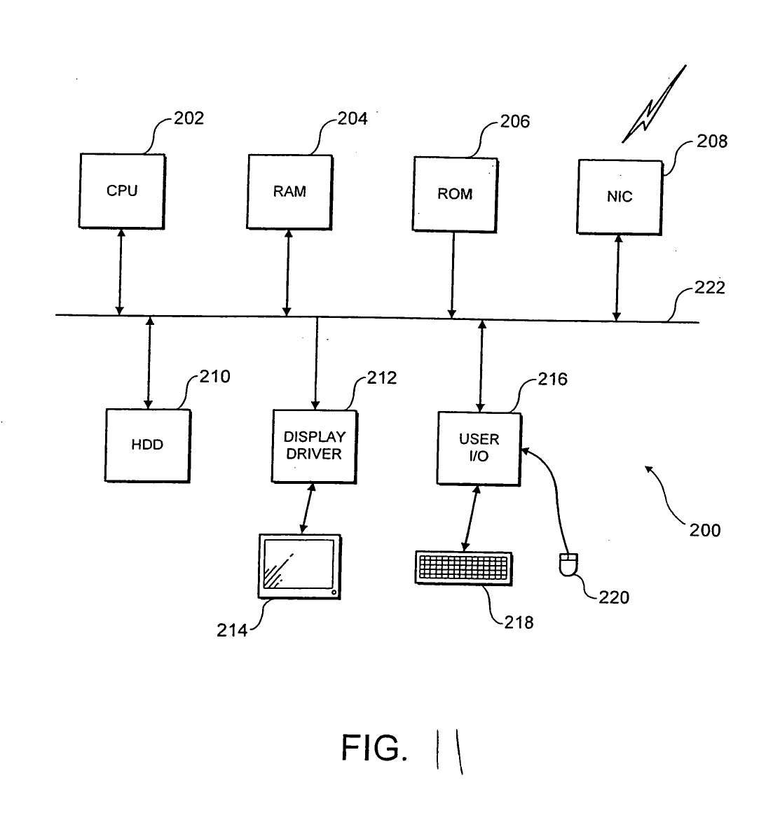

FIG. 10 is a flow diagram illustrating the generation of characteristic data for use in a test program generating tool. At step 128, the architectural definition is parsed to identify distinct program instructions. At step 130 operand range and bias data for the required operands of the identified distinct program instructions are associated therewith. At step 132 the data identifying the distinct instructions and associated operand data is stored in a database for supply to a test generation tool as part of the set of co-operative testing mechanisms.

FIG. 11 schematically illustrates a general purpose computer 200 of the type that may be used to implement the above described techniques. The general purpose computer 200 includes a central processing unit 202, a random access memory 204, a read only memory 206, a network interface card 208, a hard disk drive 210, a display driver 212 and monitor 214 and a user input/output circuit 216 with a keyboard 218 and mouse 220 all connected via a common bus 222. In operation the central processing unit 202 will execute computer program instructions that may be stored in one or more of the random access memory 204, the read only memory 206 and the hard disk drive 210 or dynamically downloaded via the network interface card 208. The results of the processing performed may be displayed to a user via the display driver 212 and the monitor 214. User inputs for controlling the operation of the general purpose computer 200 may be received via the user input output circuit 216 from the keyboard 218 or the mouse 220. It will be appreciated that the computer program could be written in a variety of different computer languages. The computer program may be stored and distributed on a recording medium or dynamically downloaded to the general purpose computer 200. When operating under control of an appropriate computer program, the general purpose computer 200 can perform the above described techniques and can be considered to form an apparatus for performing the above described technique. The architecture of the general purpose computer 200 could vary considerably and FIG. 11 is only one example.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

We claim:

1. A method for automatically generating a set of co-operative testing mechanisms for testing a data processing apparatus from an architectural definition of at least one instruction set of said data processing apparatus, said method comprising:
(i) parsing said architectural definition to identify features of the data processing apparatus to create said set of co-operative testing mechanisms;
(ii) generating from at least some of said features of said data processing apparatus a simulation tool operable to simulate the behaviour of said data processing apparatus; and
(iii) generating from at least some of said features of said data processing apparatus characteristics of said at least one instruction set for supply to a test generation tool.

2. A method as claimed in claim 1 wherein generating said simulation tool comprises:
(i) parsing the architectural definition to identify within said at least one instruction set a set of distinct instructions;
(ii) associating with respective distinct instructions encodings for said instructions;
(iii) further associating with respective distinct instructions behaviours of said instructions, said behaviours representative of said instructions within said data processing apparatus;
(iv) creating said simulation tool from said distinct instructions, said encodings and said behaviours; and
(v) associating said simulation tool within said co-operative testing mechanisms.

3. A method as claimed in claim 1, wherein generating said characteristics comprises:
(i) parsing said architectural definition to identify within said at least one instruction set a set of distinct program instructions independent of their operand values;
(ii) associating with respective distinct program instructions operand defining data specifying ranges of required operand values; and
(iii) storing said set of distinct program instructions and said operand defining data specifying ranges for supply to a test generation tool.

4. A method as claimed in claim 3, wherein said characteristics are stored in a database, said database being parsable by said test generation tool to provide a selection of distinct program instructions and associated operand defining data.

5. A method as claimed in claim 3, comprising automatically generating test program instructions by:
(i) parsing said characteristics to select a set of distinct program instructions independent of their operand values;
(ii) further parsing said characteristics to select associated operand defining data defining ranges of required operand values for said set of distinct program instructions;
(iii) forming instruction-generating program code using said set of distinct program instructions and said associated operand defining data; and
(iv) executing said instruction-generating program code to generate test program instructions.

6. A method as claimed in claim 5, wherein said parsing of said architectural definition is further operable to identify within said at least one instruction set a set of biases operable to constrain a range of instruction and operand choices.

7. A method as claimed in claim 1, wherein said co-operative testing mechanisms further include tools to manipulate the output of said test generation tool for use by said simulation tool.

8. A method as claimed in claim 1, wherein said co-operative testing mechanisms further include tools to manipulate output of said test generation tool for use by external simulation tools.

9. A method as claimed in claim 5, wherein said instruction-generating program code is operable to construct a test instruction using at least one of an at least partially user specified operand value and a random operand value to form at least one required operand of said test instruction.

10. A method as claimed in claim 5, wherein said instruction-generating program code is operable to mutate a test instruction to form a mutated test instruction differing in at least one operand value.

11. A method as in claim 5, wherein at least one of said testing mechanisms is operable to encode said test program instructions to a binary executable form.

12. A method as in claim 6, wherein at least one of said testing mechanisms is operable to encode said test program instructions to a binary executable form.

13. A method as claimed in claim 1, wherein said architectural definition is a hierarchical representation of said at least one instruction set.

14. A method as claimed in claim 1, wherein said architectural definition includes data specifying functional points of said data processing apparatus which may be accessed during execution of program instructions, said architectural definition being parsed to identify a set of combinations of functional points representing all valid combinations of functional points reachable during execution of program instructions by said data processing apparatus.

15. A method as claimed in claim 5, wherein a genetic algorithm uses said instruction-generating program code to evolve tests comprising ordered lists of program instructions.

16. A method as claimed in claim 14, wherein a genetic algorithm uses said set of combinations of functional points to evaluate a breadth of functional point coverage for a candidate test.

17. Apparatus for processing data operable to automatically generate a set of co-operative testing mechanisms for testing a data processing apparatus from an architectural definition of at least one instruction set of said data processing apparatus, said apparatus comprising logic operable to perform the steps of:
(i) parsing said architectural definition to identify features of the data processing apparatus to create said set of co-operative testing mechanisms;
(ii) generating from at least some of said features of said data processing apparatus a simulation tool operable to simulate the behaviour of said data processing apparatus; and
(iii) generating from at least some of said features of said data processing apparatus characteristics of said at least one instruction set for supply to a test generation tool.

18. Apparatus for processing data as in claim 17 further comprising logic operable to perform the steps of:
(i) parsing the architectural definition to identify within said at least one instruction set a set of distinct instructions;
(ii) associating with respective distinct instructions encodings for said instructions;
(iii) further associating with respective distinct instructions behaviours of said instructions, said behaviours representative of said instructions within said data processing apparatus;
(iv) creating said simulation tool from said distinct instructions, said encodings and said behaviours; and
(v) associating said simulation tool within said co-operative testing mechanisms.

19. Apparatus for processing data as in claim 17 further comprising logic operable to perform the steps of:
(i) parsing said architectural definition to identify within said at least one instruction set a set of distinct program instructions independent of their operand values;
(ii) associating with respective distinct program instructions operand defining data specifying ranges of required operand values; and
(iii) storing said set of distinct program instructions and said operand defining data specifying ranges for supply to a test generation tool.

20. A computer product bearing a computer program for controlling a computer to perform a method of automatically generating a set of co-operative testing mechanisms for testing a data processing apparatus from an architectural definition of at least one instruction set of said data processing apparatus, said computer program comprising code operable to perform the steps of:
(i) parsing said architectural definition to identify features of the data processing apparatus to create said set of co-operative testing mechanisms;
(ii) generating from at least some of said features of said data processing apparatus a simulation tool operable to simulate the behaviour of said data processing apparatus; and
(iii) generating from at least some of said features of said data processing apparatus characteristics of said at least one instruction set for supply to a test generation tool.
